(19) United States
(12) Patent Application Publication
(10) Pub. No.: US 2002/0051917 A1
(43) Pub. Date: May 2, 2002

(54) Apparatus and method for forming a toner image with low toner pile height

(75) Inventor: John S. Berkes, Webster, NY (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 09/894,300

(22) Filed: Jun. 28, 2001

Related U.S. Application Data
(62) Division of application No. 09/697,580, filed on Oct. 27, 2000.

(51) Int. Cl. G03G 5/047

(52) U.S. Cl. 430/58.05; 430/133; 399/159

(57) ABSTRACT

An apparatus for forming an image on a recording sheet having low toner pile height. A photoconductive member is provided, said photoconductive member includes a charge generation pattern for directing developed toner; means for recording a latent image of one color separation on said photoconductive member; means for developing said latent image on said photoconductive member; and means for transferring said developed said latent image on said photoconductive member to the recording sheet.

This invention relates generally to development of dry toner images more particularly to a photoconductive member which is to produce a resultant image on a recording sheet exhibits low toner pile height.

### BACKGROUND AND SUMMARY OF THE INVENTION

A typical electrostatographic printing machine (such as a photocopier, laser printer, facsimile machine or the like) employs an imaging member that is exposed to an image to be printed. Exposure of the imaging member records an electrostatic latent image on it corresponding to the informational areas contained within the image to be printed. The latent image is developed by bringing a developer material into contact therewith. The developed image recorded on the photoconductive member is transferred to a support material such as paper either directly or via an intermediate transport member. The developed image on the support material is generally subjected to heat and/or pressure to permanently fuse it thereto.

Two types of developer materials are typically employed in electrostatographic printing machines. One type of developer material is known as a dry developer material and comprises toner particles or carrier granules having toner particles adhering triboelectrically thereto. Another type of developer material is a liquid developer material comprising a liquid carrier or dispersant having toner particles dispersed therein.

Development with liquid developers in full color imaging processes has many advantages, such as a texturally attractive print because there is substantially no toner height build-up, whereas full color images developed with dry toners often exhibit height build-up of the image where color areas overlap. Further, full color prints made with liquid developers can be made to have either a uniformly glossy or a uniformly matte finish, whereas uniformity of finish is difficult to achieve with powder toners because of variations in the toner pile height.

High toner pile height is a major document appearance problem for powder xerography. It is obvious to the customer not only as increased document thickness but also in other undesirable ways, such as paper curl. In addition to being an aesthetic dissatisfier, paper distortion due to curl and ripple increases the jam rate and complicates paper handling and document finishing. This is objectionable in any market, but especially in the production color printing market, which demands high-speed reliable operation and is accustomed to the look and feel of lithography.

Toner pile height can be reduced by reducing toner size, but the performance of current xerographic subsystem designs would be compromised for average particle sizes less than about 5 μm. On the other hand, in conventional systems, if toner mass is reduced without reducing toner size, the toner does not completely cover the paper even in the Dmax areas. Incomplete paper coverage leads to significant color and image quality degradation, since even a small amount of white light from bare paper can reduce image chroma noticeably. This is particularly severe for high-chroma and/or low-lightness colors, such as deep blue.

A need exists for an electrostatic printing machine that can produce texturally attractive color prints with substantially no height build-up employing dry developers. A simple, relatively inexpensive, and accurate approach to produce color prints in such printing systems has been a goal in the design, manufacture and use of electrophotographic printers. This need has been particularly recognized in the process color and highlight color portion of electrophotography. The need to provide accurate and inexpensive color reproduction with dry developers has become more acute, as the demand for high quality, relatively inexpensive color images and the machines that produce them have increased.

The present invention obviates the problems noted above by utilizing a multi-color image printing apparatus for forming an image on a recording sheet, comprising: a photoconductive member, said photoconductive member includes a charge generation pattern for directing developed toner; means for recording a latent image of one color separation on said photoconductive member; means for developing said latent image on said photoconductive member; and means for transferring said developed said latent image on said photoconductive member to the recording sheet.

### BRIEF DESCRIPTION OF THE DRAWINGS

FIG. 1 is an illustration of a multicolor printing machine incorporating the present invention.

FIG. 2 is a schematic illustration of the film layer formation process employed in the present invention.

FIGS. 3 and 4 are schematic illustrations of the layer of the photoconductive member of the present invention.

FIG. 5 is a schematic illustration of the patterning of the charge generation layer of the photoconductive member of the presents invention.

The present invention will be described in connection with preferred embodiments; however, it will be understood that there is no intent to limit the invention to the embodiments described. On the contrary, the intent is to cover all alternatives, modifications, and equivalents as may be included within the spirit and scope of the invention as defined by the appended claims.

### DESCRIPTION OF THE PREFERRED EMBODIMENT

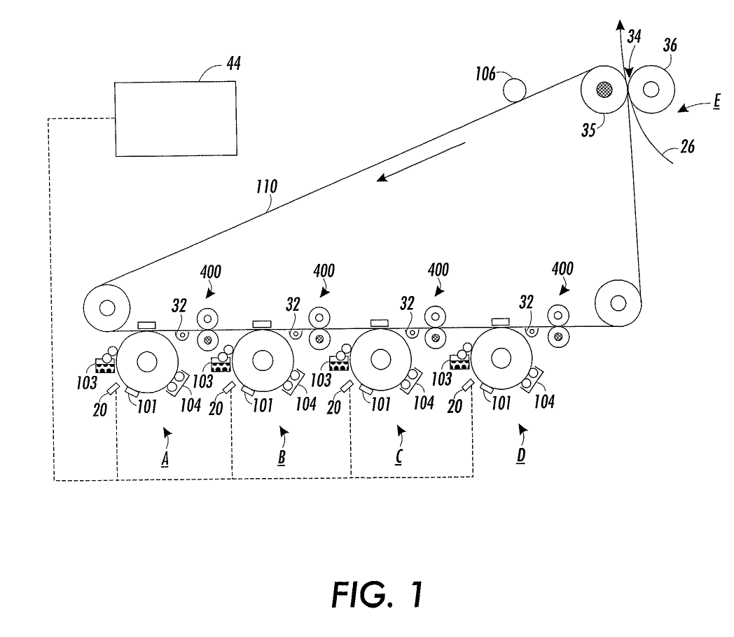

Turning now to FIG. 1, there is shown a color document imaging system incorporating the present invention. An image processing unit 44 generates a color image. Digital signals which represent the blue, green, and red density signals of the image are converted in the image processing unit into four bitmaps: yellow (Y), cyan (C), magenta (M), and black (K). The bitmap represents the values of the exposure required for each color component of the pixel. Image processing unit 44 may contain a shading correction unit, an undercolor removal unit (UCR), a masking unit, a dithering unit, a gray level processing unit, and other imaging processing sub-systems known in the art. The image processing unit 44 can store bitmap information for subsequent images or can operate in a real time mode.

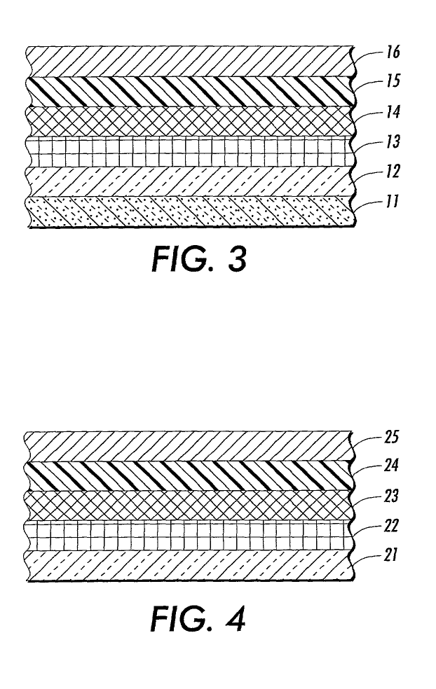

At stage A, toner of a first color is formed on either a belt or drum 100. The photoconductive member is preferably a drum of the type which is typically multilayered and has a substrate, a conductive layer, an optional adhesive layer, an optional hole blocking layer, a charge generating layer and a charge transport layer. For example, one type of multilayered photoreceptor that has been employed in electrophotographic imaging systems is schematically shown in FIG. 3, and comprises a substrate 11, a conductive ground plane 12, a charge blocking layer 13, a charge generation layer 14 (including photogenerating material in a binder), a charge transport layer 15 (including charge transport material in a binder), and an optional overcoating layer 16. A second type of multi-layered photoreceptor comprising an inverted structure of several layers of the photoreceptor of FIG. 3 is schematically shown in FIG. 4, and comprises a substrate 21, a conductive ground plane 22, a charge transport layer 23, a charge generation layer 24, and a protective and blocking overcoating layer 25. Typically, layer 25 is an amorphous layer of 2% arsenic and 98% selenium. The top blocking layer is needed in this configuration to prevent holes from the corona charge from entering the charge generation layer and then discharging the negative charge which forms the image on the conductive ground plane.

The drum is charged by charging unit 101. Raster output scanner (ROS) 20, controlled by image processing unit 44, writes a first color image by selectively erasing charges on the drum 100. The ROS 20 writes the image information pixel by pixel. It should be noted that either discharged area development (DAD) can be employed in which discharged portions are developed or charged area development (CAD) can be employed in which the charged portions are developed with toner. The photoreceptor of the present invention creates a uniform hexagonal distribution charge pattern in the image areas by patterning the charge generation layer of the photoreceptor this in turn allows a mono layer of toner particles to be equally spaced from each other on the surface of the photoreceptor, details of the present invention will be discussed supra.

After the electrostatic latent image has been recorded, drum 100 advances the electrostatic latent image to development station 103. Dry developer material is supplied by development station 103 to develop the latent image. In the case of CAD development, the charge of the toner particles is opposite in polarity to the charge on the photoconductive surface, thereby attracting toner particles thereto. The latent image is developed with a less than monolayer coverage of toner particles. On the average, the uniformity of the development is such that toner particles are near neighboring toner particles. Development station 103 employs small size toner, preferably having average particle size of about 5 □m.

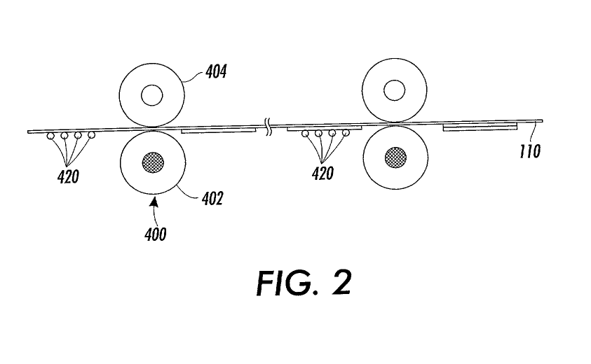

The developed image is electrostatically transferred to the compliant, low surface energy intermediate member by applying an electrical bias between the drum 100 and intermediate member 110. Any residual toner on the drum 100 is removed with a cleaner 104. Intermediate member 110 may be either a roll or an endless belt with a conductive substrate and a compliant overcoat. The path of the belt is defined by a plurality of internal rollers. Intermediate member 110 includes an optional plurality of heating elements 32 in close proximity to the toned image such that the heat causes the toner particles present on the surface to soften, as illustrated by the particles 420 in FIG. 2. As indicated in FIG. 2, the softened toner particles pass through film layer formation station 400. Station 400 includes a heated roller 402 which is in contact with the softened toner image and a backup pressure roll 404 behind intermediate member 110. Filming station 400 spreads the softened toner particles into a thin film so that the small gaps between neighboring toner particles are covered with toner without degradation of the image. The toner flow required is very small to cover the spaces between the toner particles. Ideally, the film forming station should form a film of the desired thickness (about 1 □m) regardless of the local toner coverage. One possible way of achieving this is to make the heated roller 402 self-spaced from the intermediate belt at the desired thickness.

At stage B illustrated in FIG. 1, formation of a second color takes place in the same manner as described above. The drum 100 is charged with charging unit 101. The belt is exposed by ROS 20 according to second color image bitmap information. After the electrostatic latent image has been recorded, drum 100 advances the electrostatic latent image to development station 103. Dry developer material with toner of the second color is supplied by development station 103 to develop the latent image.

The developed image is electrostatically transferred to the intermediate member by an electrical bias voltage between drum 100 and belt 110. (Any residual toner on drum 100 is cleaned by 104.) The developed second color image is superimposed on the previous first color image. Heat from the optional heater 32 softens the toner particles. The softened toner particles on the intermediate member 110 pass through the heated filming station 400 which spread the softened image into a thin film without degradation of the image.

The process is repeated for the next two colors at stages C and D. A multi-layer film image is formed by superimposing black, yellow, magenta, and cyan toners. The full-color image advances to transfusing stage E.

At transfuse nip 34 illustrated in FIG. 1, the multi-layer full-color film image is transfused to the recording sheet 26 by the application of heat and pressure between a heated roll 35 behind the intermediate belt 110 and a backup pressure roll 36 behind the recording sheet. Moreover, recording sheet 26 may have a previously transferred toner image present on the back surface thereof as the result of a prior imaging operation, i.e. duplexing. As the recording sheet passes through the transfuse nip, the multi-layer toner film adheres to the surface of the recording sheet, and due to greater attractive forces between the paper and toner film, as compared to the attraction between the toner film and the low surface energy surface of the compliant intermediate member 110, the multilayer toner film is transferred to the recording sheet as a full-color image. The transfused image becomes permanent once it advances past the transfuse nip and is allowed to cool below the softening temperature of the toner materials. The cycle for forming another document is initiated following the cleaning of any residual toner from the intermediate belt by a cleaner 106.

Now, turning to the present invention in more detail, the photoreceptor of the present invention creates a uniform hexagonal distribution of equally spaced toner particles by patterning the charge generation layer of the photoreceptor. The photoreceptor design that when used with development of a mono-layer of relatively large sized toner particles in a spaced distribution on a intermediate member enables toner spreading into a thin uniform layer that produces improved print quality. The photoreceptor is designed to create a hexagonal pattern in the charge generation layer, which after being charged and expose to an image, directs developed toner placement to controlled latent image sites outline by the patterned charge generation layer.

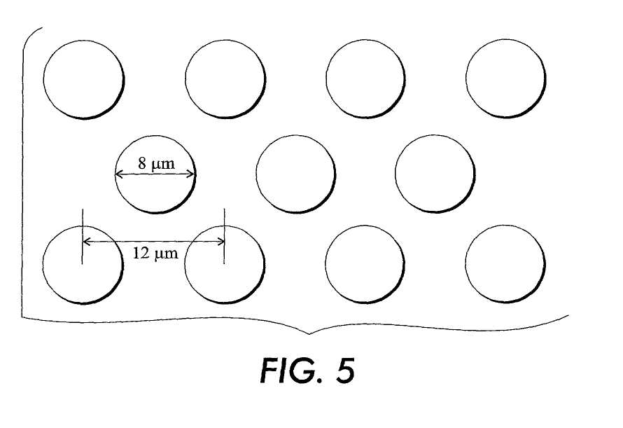

FIG. 5 shows, a charge generation pattern is given for the case where 7 micron toner is used. Larger toner sizes would require greater toner spacing. In the fabrication of the photoreceptor of the present invention the charge generation dots can be created by a very high quality lithographic printing or by a photo patterning and etching of a photoresist coated generation film.

The following is a description of layers, and the formation thereof, which may be employed in photoreceptors in accordance with the present invention. Other arrangements may also be used. The photoreceptors in accordance with the present invention are preferably prepared by first providing a substrate. The substrate may be opaque or substantially transparent and may comprise any of numerous suitable materials having the required mechanical properties. The substrate may comprise a layer of electrically non-conductive material or a layer of electrically conductive material such as an inorganic or organic composition. If a non-conductive material is employed, it is necessary to provide an electrically conductive ground plane over such non-conductive material. If a conductive material is used as the substrate, a separate ground plane layer may not be necessary.

The substrate is preferably flexible and may have any of a number of different configurations such as, for example, a sheet, a scroll, an endless flexible belt, and the like. Preferably, the substrate is in the form of an endless flexible belt. The photoreceptor in this invention can also be coated on a rigid opaque conducting substrate such as an aluminum drum. In that case, the photoreceptor would be erased from the front. As electrically non-conducting materials, there may be employed various resins known for this purpose, including polyesters, polycarbonates, polyamides, polyurethanes, and the like.

The substrate preferably comprises a commercially available biaxially oriented polyester known as Mylar, available from E.I. du Pont de Nemours & Co., Melinex, available from ICI Americas Inc. or Hostaphan, available from American Hoechst Corporation. Other materials which the substrate may comprise include polymeric materials such as polyvinyl fluoride, available as Tedlar from E.I. du Pont de Nemours & Co., and polyimides, available as Kapton from E.I. du Pont de Nemours & Co.

The photoreceptor can also be coated on an insulating plastic drum providing that a conducting ground plane was coated on its surface. When a conductive substrate is employed, any suitable conductive material may be used. For example, the conductive material may include metal flakes, powders or fibers, such as aluminum, titanium, nickel, chromium, brass, gold, stainless steel, carbon black, graphite, or the like, in a binder resin including metal oxides, sulfides, silicides, quaternary ammonium salt compositions, conductive polymers such as polyacetylene or their pyrolysis and molecular doped products, charge transfer complexes, polyphenylsilane and molecular doped products from polyphenylsilane.

A conducting metal drum made from a material such as aluminum can be used, as well as a conducting plastic drum. The preferred thickness of the substrate depends on numerous factors, including mechanical performance required and economic considerations. The thickness of the substrate is typically within the range of from about 65 micrometers to about 150 micrometers, preferably from about 75 micrometers to about 125 micrometers for optimum flexibility and minimum induced surface bending stress when cycled around small diameter rollers, e.g., 19 millimeter diameter rollers.

The substrate for a flexible belt may be of substantial thickness, for example, over 200 micrometers, or of minimum thickness, for example, less than 50 micrometers, provided there are no adverse effects on the final photoconductive device.

If an aluminum drum is used, the thickness must be sufficient to provide the necessary rigidity. The surface of the substrate to which a layer is to be applied is preferably cleaned to promote greater adhesion of such a layer. Cleaning may be effected by exposing the surface of the substrate layer to plasma discharge, ion bombardment and the like. Other methods such as solvent cleaning may be used. The electrically conductive ground plane, if employed, is positioned over the substrate. Suitable materials for the electrically conductive ground plane include aluminum, zirconium, niobium, tantalum, vanadium, hafnium, titanium, nickel, stainless steel, chromium, tungsten, molybdenum, copper and the like, and mixtures and alloys thereof, with aluminum, titanium and zirconium being preferred.

The ground plane may be applied by known coating techniques, such as solution coating, vapor depositing and sputtering. A preferred method of applying an electrically conductive ground plane is by vacuum deposition. Other suitable methods may also be used. Preferred thicknesses of the ground plane are within a substantially wide range, depending on the optical transparency and flexibility desired for the electrophotoconductive member.

Accordingly, for a flexible photoresponsive imaging device, the thickness of the conductive layer is preferably between about 20 Angstroms and about 750 Angstroms, more preferably from about 50 Angstroms to about 200 Angstroms, for an optimum combination of electrical conductivity, flexibility and light transmission. However, the ground plane can be opaque and front erase employed.

A blocking layer may be positioned over the conductive layer. Nevertheless, if desired, a charge blocking layer may be employed in the present invention and may be applied over the conductive layer.

For the inverted photoreceptor structure of FIG. 4, the hole blocking layer 25 prevents holes from the charging surface from migrating through the photoreceptor to the ground plane, thus destroying the latent image. For negatively charged photoreceptors, any suitable hole blocking layer capable of forming a barrier to prevent hole injection from the conductive layer to the opposite photoconductive layer may be utilized. The hole blocking layer may include polymers such as polyvinylbutyral, epoxy resins, polyesters, polysiloxanes, polyamides, polyurethanes and the like, as disclosed in U.S. Pat. Nos. 4,338,387, 4,286,033 and 4,291,110. Other suitable materials may be used.

The charge generation layer in accordance with the present invention comprises charge generation film forming polymer and photogenerating particles. The charge generation layer of some embodiments in accordance with the present invention further comprises one or more dopant comprising organic molecules containing basic electron donor or proton acceptor groups. Suitable charge generation film forming polymers include those described, for example, in U.S. Pat. No. 3,121,006. The film forming polymer preferably adheres well to the layer on which the charge generation layer is applied, preferably dissolves in a solvent which also dissolves any adjacent adhesive layer (if one is employed) and preferably is miscible with the copolyester of any adjacent adhesive layer (if one is employed) to form a polymer blend zone. For example, suitable film forming materials include polyvinylcarbazole (PVK), phenoxy resin, polystyrene, polycarbonate resin, such as those available under the tradenames Vitel PE-100 (available from Goodyear) and Lexan 141 and Lexan 145 (available from General Electric).

Other suitable materials may be used. Examples of materials which are suitable for use as photogenerating particles include, for example, particles comprising amides of perylene and perinone, chalcogens of selenium II-VI or tellurium III-V compounds, amorphous selenium, trigonal selenium, and selenium alloys such as, for example, selenium-tellurium, selenium-telluriumarsenic, selenium arsenide, and phthalocyanine pigments such as the X-form of metal free phthalocyanine described in U.S. Pat. No. 3,357,989, metal phthalocyanines such as vanadyl phthalocyanine and copper phthalocyanine, dibromoanthanthrone, squarylium, quinacridones available from E.I. du Pont de Nemours & Co. under the tradename Monastral Red, Monastral Violet and Monastral Red Y, dibromo anthanthrone pigments such as those available under the tradenames Vat orange 1 and Vat orange 3, benzimidazole perylene, substituted 2,4-diamino-triazines disclosed in U.S. Pat. No. 3,442,781, polynuclear aromatic quinones available from Allied Chemical Corporation under the tradenames Indofast Double Scarlet, Indofast Violet Lake B, Indofast Brilliant Scarlet and Indofast Orange, and the like.

Particularly preferred photogenerating particles include particles comprising vanadyl phthalocyanine, trigonal selenium, and benzimidazole perylene. Multi-photogenerating layer compositions may be utilized where a photoconductive layer enhances or reduces the properties of the photogeneration layer. Examples of this type of configuration are described in U.S. Pat. No. 4,415,639. Other suitable photogeneration materials known in the art may also be utilized, if desired.

Charge generation layers comprising a photoconductive material such as vanadyl phthalocyanine, titanyl phthalocyanine, metal free phthalocyanine, benzimidazole perylene, amorphous selenium, trigonal selenium, selenium alloys such as selenium-tellurium, selenium-telluriumarsenic, selenium arsenide, and the like and mixtures thereof are especially preferred because of their sensitivity to white light. Vanadyl phthalocyanine, titanyl phthalocyanine, metal free phthalocyanine and tellurium alloys are also preferred because these materials provide the additional benefit of being sensitive to infra-red. The preferred photoconductive materials for use in the charge generation layers are benzimidazole perylene, trigonal selenium and vanadyl phthalocyanine. The photogeneration layer in some embodiments in accordance with the present invention is applied over the conductive layer (or any charge blocking layer over the substrate) and the charge transport layer is applied over the photogeneration layer.

The charge generation coating composition is applied by a very high quality lithographic printing or by a photo patterning and etching of a photoresist coated generation film.

The charge generation coating composition is then dried to remove the solvent. Drying of the deposited coating may be effected by any suitable conventional technique such as oven drying, infrared radiation drying, air drying and the like, to remove substantially all of the solvent utilized in applying the coating.

The photogeneration layer of the invention is generally of a thickness within the range of from about 0.1 micrometer to about 5.0 micrometers, preferably from about 0.3 micrometer to about 3.0 micrometers. Thicknesses outside these ranges can be selected, providing the objectives of the present invention are achieved. The charge transport material is generally any suitable transparent organic polymeric or non-polymeric material capable of supporting the injection of photogenerated holes from the charge generation layer and allowing the transport of these holes through the layer to selectively discharge the surface charge.

It is, therefore, apparent that there has been provided, in accordance with the present invention. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

We claim:

1. A multi-color image printing apparatus for forming an image on a recording sheet, comprising:
a photoconductive member, said photoconductive member includes a charge generation pattern for directing developed toner;
means for recording a latent image of one color separation on said photoconductive member
means for developing said latent image on said photoconductive member, developing means develops said latent image in precisely places a less than monolayer of toner particles in accordance to said charge generation pattern; and
means for transferring said developed said latent image on said photoconductive member to the recording sheet.

2. The apparatus of claim 1, wherein said transferring means includes:
means for transferring said developed said latent image on to an intermediate member;
a filming station for spreading toner particles to form a film layer; means for superimposing a similarly formed additional color separation on said one color separation to form a multi layer film on said intermediate member and
transfusing said multi-color film layer color image from said intermediate member onto the recording sheet.

3. The apparatus of claim 1, wherein said film forming stations include:
means for heating said less than monolayer of toner particles to a temperature sufficient to cause the toner particles present on the intermediate member to soften; and
a heated roller for forming a film layer by spreading toner particles with less than a monolayer coverage.

4. The apparatus of claim 1, wherein said charge generation pattern comprises a hexagonal pattern.

5. A multilayered photoreceptor for developing toner on the surface of the multilayered photoreceptor, comprising
a substrate;
a conductive ground plane;
a charge blocking layer;
a charge generation layer, said charge layer includes a predefine charge generation pattern for directing developed toner on the surface of the multilayered photoreceptor in a predefine pattern;
a charge transport layer; and
an optional overcoating layer.

6. A method for fabricating a photoconductive member, comprising the steps of:
providing a substrate;
applying an electrically conductive ground plane onto the substrate;
applying a photogeneration layer onto the electrically conductive ground plane; and
lithographic coating a charge generation layer on the transport layer, said lithographic coating step includes the step of defining a predefined pattern into the charge generation layer so that after the photoconductor member is charged and expose to an image, a resulting charge pattern directs placement of toner to sites outline by the patterned charge generation layer.
